(19) United States
(12) Patent Application Publication
(10) Pub. No.: US 2025/0167626 A1
(43) Pub. Date: May 22, 2025

(54) DAMPER GEL TANK AND VOICE COIL MOTOR

(71) Applicant: Lanto Electronic Limited, Kunshan City (CN)

(72) Inventors: Shao Chung CHANG, Kunshan City (CN); Yu Hsiang CHENG, Kunshan City (CN); Meng Ting LIN, Kunshan City (CN); Chun Kai CHEN, Kunshan City (CN)

(21) Appl. No.: 18/948,887

(22) Filed: Nov. 15, 2024

(30) Foreign Application Priority Data
Nov. 16, 2023 (CN) 2023230969945

(51) Int. Cl. H02K 5/24; H02K 33/18

(52) U.S. Cl. CPC H02K 5/24; H02K 33/18

(57) ABSTRACT

A damper gel tank is provided and includes a body part and a deforming part which form gel accommodation space. The deforming part includes a recession part connected to the body part and a protrusion part connected to the recession part. The bottom of the recession part and the lower limit position of the acceptable range of gel accommodation of the gel accommodation space are disposed flush, and the recession part recesses along the radial direction of the body part. The top of the protrusion part and the upper limit position of the acceptable range of gel accommodation of the gel accommodation space are disposed flush, and the protrusion part projects from the recession part. The damper gel tank solves the problem of the current damper gel tank that visual distinction whether the damper gel fills the damper gel tank is inconvenient.

### CROSS-REFERENCE TO RELATED APPLICATIONS

This application claims the priority benefit of Chinese Patent Application Serial Number 2023230969945, filed on Nov. 16, 2023, the full disclosure of which is incorporated herein by reference.

### TECHNICAL FIELD OF THE INVENTION

The present disclosure relates to a technical field of dampers, and particularly relates to a damper gel tank and a voice coil motor.

### DESCRIPTION OF THE PRIOR ART

In order to suppress the frequency response of a voice coil motor (VCM) on exterior vibration (e.g. jiter), a damper pin and a damper gel may be disposed in the voice coil motor. The damper gel may be disposed in a damper gel tank, and the damper pin may slide in the damper gel to suppress the frequency response of the voice coil motor on the exterior vibration.

When the voice coil motor is assembled, the damper gel requires injecting into the damper gel tank. Because the current damper gel tank does not have any obvious mark to reveal whether the damper gel fills the damper gel tank, it is hard to visually distinguish whether the damper gel fills the damper gel tank when the damper gel is dispensed (i.e., the damper gel is injected into the damper gel tank). Hence, the current damper gel tank has the problem that visual distinction whether the damper gel fills the damper gel tank is inconvenient.

### SUMMARY

The object of the present disclosure is to provide a damper gel tank which is convenient to visually distinguish whether the damper gel fills the damper gel tank. The damper gel tank includes a body part and a deforming part. The deforming part forms gel accommodation space with the body part and includes a recession part and a protrusion part. The body part is connected to the recession part, the bottom of the recession part is disposed flush with the lower limit position of the acceptable range of gel accommodation of the gel accommodation space, and the recession part recesses along the radial direction of the body part. The protrusion part is connected to the recession part, the top of the protrusion part is disposed flush with the upper limit position of the acceptable range of gel accommodation of the gel accommodation space, and the protrusion part projects from the recession part.

In some embodiments of the present disclosure, the recession part is disposed on the top end of the body part.

In some embodiments of the present disclosure, the recession part includes a first horizontal plane. The first horizontal plane extends to the body part and is disposed flush with the lower limit position of the acceptable range of gel accommodation of the gel accommodation space.

In some embodiments of the present disclosure, the first horizontal plane extends from the body part in the direction far away from the central axial line of the body part.

In some embodiments of the present disclosure, the recession part further includes a first vertical plane, and the first horizontal plane extends to the first vertical plane.

In some embodiments of the present disclosure, the recession part includes the first horizontal plane, and the protrusion part is disposed on the first horizontal plane.

In some embodiments of the present disclosure, the protrusion part further includes a second horizontal plane. The second horizontal plane extends to the recession part and is disposed flush with the upper limit position of the acceptable range of gel accommodation of the gel accommodation space.

In some embodiments of the present disclosure, the recession part includes the first vertical plane connected to the protrusion part.

In some embodiments of the present disclosure, the second horizontal plane extends to the first vertical plane.

In some embodiments of the present disclosure, the protrusion part further includes a second vertical plane, and the second horizontal plane extends to the second vertical plane.

In some embodiments of the present disclosure, the second horizontal plane extends from the second vertical plane in the direction far away from the central axial line of the body part.

In some embodiments of the present disclosure, the damper gel tank further includes a wall, and the wall encompasses the recession part.

In some embodiments of the present disclosure, the recession part further includes the first vertical plane, and the first vertical plane and the inner side wall of the wall are disposed with coplanarity.

In some embodiments of the present disclosure, the wall is disposed on the top of the recession part.

The present disclosure further provides a voice coil motor including a case, a motion component, a damper pin and the aforementioned damper gel tank. The motion component is movably disposed on the case. The damper gel tank is disposed on the motion component, and there is damper gel disposed in the damper gel tank. The damper pin is fixed on the case and is partially inserted into the damper gel.

In some embodiments of the present disclosure, the damper gel tank includes the wall. The wall encompasses the deforming part and protrudes with respect to the motion component.

The present disclosure discloses: the body part and the deforming part. The deforming part forms the gel accommodation space with the body part and includes the recession part and the protrusion part. The body part is connected to the recession part, the bottom of the recession part is disposed flush with the lower limit position of the acceptable range of gel accommodation of the gel accommodation space, and the recession part recesses along the radial direction of the body part. The protrusion part is connected to the recession part, the top of the protrusion part is disposed flush with the upper limit position of the acceptable range of gel accommodation of the gel accommodation space, and the protrusion part projects from the recession part.

Because the bottom of the recession part is disposed flush with the lower limit position of the acceptable range of gel accommodation of the gel accommodation space, it indicates that the amount of gel injection in the gel accommodation space has been the lower limit of the acceptable range of gel accommodation and the gel accommodation space has reached the minimum value of the full injection amount of the damper gel when the damper gel is injected into the gel accommodation space and the damper gel contacts the bottom of the recession part. Because the recession part recesses along the radial direction of the body part, it is beneficial for visual distinction during the process of dispensing the damper gel (i.e., injecting the damper gel into the gel accommodation space). When dispensing the damper gel is performed by a worker, whether the damper gel fills the gel accommodation space would be easily distinguished by the vision of the worker; when dispensing the damper gel is performed by an automatic machine, the structure features generated by the deforming part is transformed into image features by mechanical vision to label and control the height of the gel surface accurately and fast.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 depicts a 3D diagram and a partial enlarged view diagram of a voice coil motor according to the first embodiment of the present disclosure.

FIG. 2 depicts a 3D cross section diagram (including damper gel and partially displaying the damper gel) of one part of a damper gel tank according to the second embodiment of the present disclosure.

FIG. 3 depicts the cross section left view diagram (including the damper gel and partially displaying the damper gel) of one part of the damper gel tank according to the second embodiment of the present disclosure.

FIG. 4 depicts the 3D diagram (omitting the damper gel) of the damper gel tank according to the second embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the aforementioned accompanying drawings are used to distinguish similar objects and need not be used to describe a particular order or sequence. Furthermore, the terms “comprising” and “having”, and any variation thereof, are intended to encompass a non-exclusive inclusion, for example, a series of steps or units comprising processes, methods, systems, products or equipment need not be limited to those steps or units clearly listed but may include other steps or units not clearly listed or inherent to those processes, methods, products or equipment.

### The First Embodiment

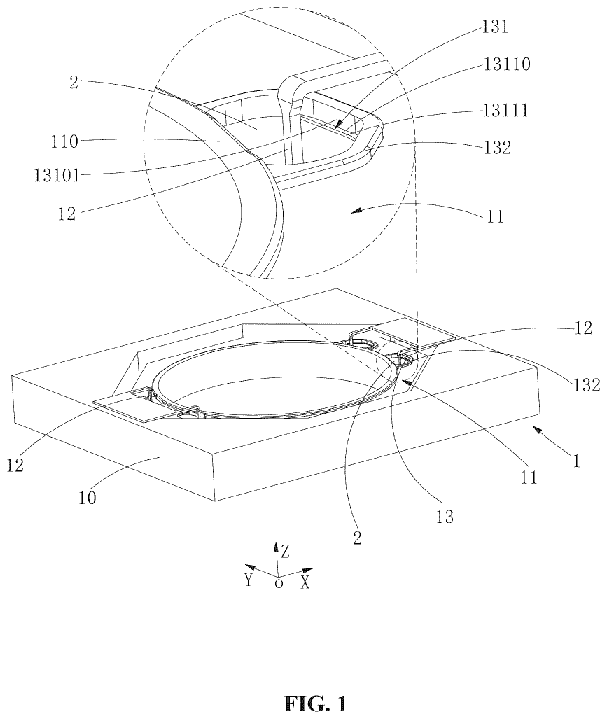

As shown in FIG. 1, the present embodiment provides a voice coil motor 1 including a case 10, a motion component 11, a plurality of damper pins 12 and a plurality of damper gel tanks 13, and each of the plurality of damper pins 12 is correspondingly disposed with the corresponding damper gel tank 13. Each of the plurality of damper pins 12 is fixed to the case 10. For example, the number of the plurality of damper pins 12 and the number of the plurality of damper gel tanks 13 may be all four. The two of the four damper gel tanks may be disposed on one side of the motion component 11, and the other two of the four damper gel tanks may be disposed on the other side of the motion component 11. The motion component 11 is movably disposed on the case 10, each of the plurality of damper gel tanks 13 is disposed on the motion component 11, there is damper gel 2 disposed in each of the plurality of damper gel tanks 13, and each of the plurality of damper pins 12 is fixed on the case 10 and is partially inserted into the damper gel 2.

As shown in FIG. 1, each of the plurality of damper gel tanks 13 is disposed on the motion component 11. Each of the plurality of damper gel tanks 13 and the motion component 11 may be integrally formed. The shape of the motion component 11 may be a polygonal prism, and the motion component 11 may be disposed on the middle position of the case 10 and move with respect to the case 10 along the direction vertical to the central axial line of the case 10 or move along the direction of the central axial line of the case 10. The motion component 11 may be embedded in the through hole in the middle of the case 10 and be separately disposed with the case 10. Each of the plurality of damper gel tanks 13 may be disposed on the upper part of the motion component 11. In some embodiments, a lens, an aperture assembly or an image sensor may be disposed on the motion component 11.

As shown in FIG. 1, there is damper gel 2 disposed in each of the plurality of damper gel tanks 13. The motion component 11 may drive each of the plurality of damper gel tanks 13 and the corresponding damper gel 2 to move when moving. The damper gel 2 may be gel. For convenience to explain, Cartesian coordinate system O-xyz may be disposed in each figure. The positive direction of x-axis, the positive direction of y-axis and the positive direction of z-axis remain the same in each figure. The x-axis is parallel to the length direction of the case 10, the y-axis is parallel to the width direction of the case 10, and the z-axis is vertical to the upper surface and the lower surface of the case. The top surface of the motion component 11 may be parallel to XOY plane.

As shown in FIG. 1, each of the plurality of damper pins 12 may be disposed in parallel with the z-axis. The shape of each damper pin 12 may be shown as a column. After being partially inserted into the corresponding damper gel 2, each damper pin 12 may slide in the corresponding damper gel 2 along the radial direction thereof; for example, each damper pin 12 may slide along the direction vertical to the z-axis. Because the damper gel 2 has retardation effects on each damper pin 12, the frequency response of the voice coil motor 1 on the exterior vibration (e.g. jiter) may be suppressed. Each damper gel tank 13 may be a polygonal prism tank.

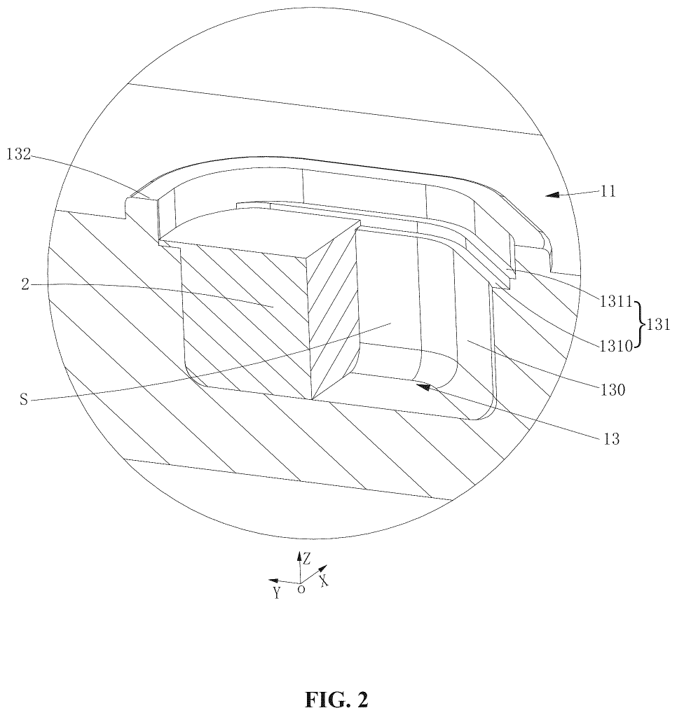

As shown in FIG. 2, each damper gel tank 13 may include a body part 130 and a deforming part 131, and the deforming part 131 and the body part 130 form gel accommodation space S. The deforming part 131 includes a recession part 1310 and a protrusion part 1311, the body part 130 is connected to the recession part 1310, and the protrusion part 1311 is connected to the recession part 1310. The bottom of the recession part 1310 is disposed flush with the lower limit position of the acceptable range of gel accommodation of the gel accommodation space S, and the recession part 1310 recesses along the radial direction of the body part 130. The protrusion part 1311 projects from the recession part 1310.

As shown in FIG. 2, when the voice coil motor 1 (the voice coil motor 1 may refer to FIG. 1) is assembled, the damper gel 2 requires injecting into the gel accommodation space S. The level surface of the damper gel 2 may gradually rise from the bottom surface of the body part 130 along the direction parallel to the z-axis. When the level surface of the damper gel 2 rises to contact the bottom surface of the recession part 1310, it indicates that the level surface of the damper gel 2 has reached the lower limit position of the acceptable range of gel accommodation of the gel accommodation space S. When the level surface of the damper gel 2 rises to reach the top surface of the protrusion part 1311, it indicates that the level surface of the damper gel 2 has reached the upper limit position of the acceptable range of gel accommodation of the gel accommodation space S.

As shown in FIG. 2, optionally, each damper gel tank 13 includes a wall 132, and the wall 132 encompasses the deforming part 131 and projects with respect to the motion component 11. The wall 132 may be disposed on the top end of the deforming part 131. The wall 132 may be collaboratively formed by the boss 110 (the boss may refer to FIG. 1) of the motion component 11 in the prior art and a C-shaped wall. The wall 132 may project from the top surface of the motion component 11 along the positive direction parallel to the z-axis. The configuration of encompassing the deforming part 131 by the wall 132 may prevent the damper gel 2 in the gel accommodation space S from overflowing. In addition, because the wall 132 is added to the damper gel tank 13, the depth of accommodating the damper gel 2 by each damper gel tank 13 may increase, and the contact area between each damper pin 12 (the damper pin 12 may refer to FIG. 1, hereinafter) and the damper gel 2 may increase, i.e., the suppressing effects of each damper pin 12 on the frequency response of the exterior vibration (e.g. jiter) may enhance.

### The Second Embodiment

As shown in FIG. 2, the present embodiment provides the damper gel tank 13 including the body part 130 and the deforming part 131, and the deforming part 131 and the body part 130 form the gel accommodation space S. The deforming part 131 includes the recession part 1310, and the body part 130 is connected to the recession part 1310. The bottom of the recession part 1310 is disposed flush with the lower limit position of the acceptable range of gel accommodation of the gel accommodation space S, and the recession part 1310 recesses along the radial direction of the body part 130.

As shown in FIG. 2, the damper gel tank 13 is configured to accommodate the damper gel 2. The body part 130 may be a polygonal prism cavity and have an opening, and the facing direction of the opening may be the positive direction parallel to the z-axis. The shape and the size of the body part 130 may be the same as the shape and the size of the corresponding part of the current damper gel tank. The deforming part 131 may be the part of the damper gel tank 13 of which the shape varies along the radial direction of the body part 130. The deforming part 131 may be the C-shaped recession formed by extending outwardly from the sidewall of the body part 130 along the radial direction of the body part 130. The deforming part 131 may be the C-shaped recession formed by extending outwardly from the sidewall of the body part 130 along the direction vertical to the z-axis. The deforming part 131 may be also the C-shaped protrusion part formed by extending inwardly from the sidewall of the body part 130 along the radial direction of the body part 130. The deforming part 131 may be also the C-shaped protrusion part formed by extending inwardly from the sidewall of the body part 130 along the direction vertical to the z-axis.

As shown in FIG. 2, the trend of the deforming part 131 may be shown as the C shape, and the cross section of the deforming part 131 may be shown as a step shape. The deforming part 131 may be disposed on the top end of the body part 130. The recession part 1310 and the body part 130 may be integrally formed and be connected. The damper gel 2 may be injected into the gel accommodation space S, i.e., the damper gel 2 injected into the gel accommodation space S may contact the body part 130 and the deforming part 131. The acceptable range of gel accommodation of the gel accommodation space S is the maximum acceptable range of accommodating the damper gel 2 by the gel accommodation space S. The acceptable range of gel accommodation of the gel accommodation space S includes a value range including an upper limit value and a lower limit value. The lower limit position of the acceptable range of gel accommodation of the gel accommodation space S may be the lower limit interface of the acceptable range of gel accommodation of the gel accommodation space S.

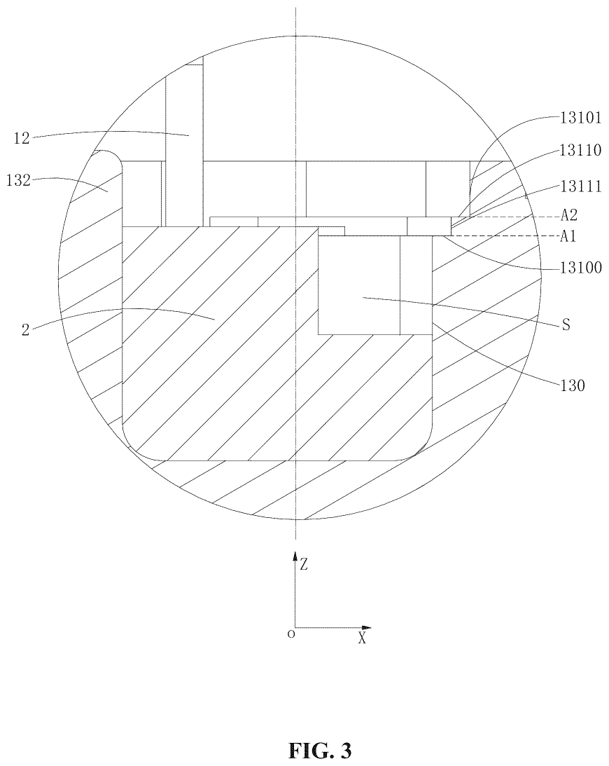

Please refer to FIG. 2 and FIG. 3. The plane passing through the bottom surface of the recession part 1310 and being parallel to the XOY plane is a plane A1, and the top surface of the body part 130 overlaps the bottom surface of the recession part 1310. In other words, the lower limit position of the acceptable range of gel accommodation of the gel accommodation space S may be the plane A1. The part of the damper gel tank 13 from the plane A1 to the negative direction of the z-axis is the body part 130. The cavity of the damper gel tank 13 from the top surface of the motion component 11 to the negative direction of the z-axis is the gel accommodation space S. The plane passing through the top surface of the protrusion part 1311 and being parallel to the XOY plane is a plane A2. The height of the plane A2 is greater than the height of the plane A1. The part of the deforming part 131 from the plane A1 to the top surface of the motion component 11 except the protrusion part 1311 is the recession part 1310.

Please refer to FIG. 2 and FIG. 3. The part of the deforming part 131 from the plane A1 to the plane A2 is the protrusion part 1311. The parts of the motion component 11 located on the top surface of the motion component 11 and encompassing the corresponding damper gel tanks 13 are walls 132. The lower limit position of the acceptable range of gel accommodation of the gel accommodation space S overlaps the plane A1. The upper limit position of the acceptable range of gel accommodation of the gel accommodation space S overlaps the plane A2. In other words, when the height of the level surface of the damper gel 2 injected into the gel accommodation space S is between the plane A1 and the plane A2, it indicates that the injected amount of the damper gel 2 meets requirements. The trend of the recession part 1310 may be shown as the C shape, and the cross section of the recession part 1310 may be L-shaped. The plane A2 may be lower than the top surface of the motion component 11.

Please refer to FIG. 2 and FIG. 3. Because the bottom surface of the recession part 1310 is disposed flush with the lower limit position of the acceptable range of gel accommodation of the gel accommodation space S, it indicates that the amount of gel injection in the gel accommodation space S has been the lower limit of the acceptable range of gel accommodation and the gel accommodation space S has reached the minimum value of the full injection amount of the damper gel 2 when the damper gel 2 is injected into the gel accommodation space S and the damper gel 2 contacts the bottom of the recession part 1310. Because the recession part 1310 recesses along the radial direction of the body part 130, the damper gel 2 is easily distinguished by the vision when the damper gel 2 is dispensed (i.e., the damper gel 2 is injected into the gel accommodation space S), and whether the damper gel 2 fills the gel accommodation space S would be easily distinguished by the vision.

As shown in FIG. 2, optionally, the recession part 1310 is disposed on the top end of the body part 130. The shape of the recession part 1310 may be the step shape and outwardly recesses with respect to the sidewall of the body part 130. The bottom of the recession part 1310 may be connected to the top end of the body part 130. Because the top end of the body part 130 is open and the recession part 1310 is disposed on the top end of the body part 130, it may be convenient to observe the recession part 1310 without obstructions.

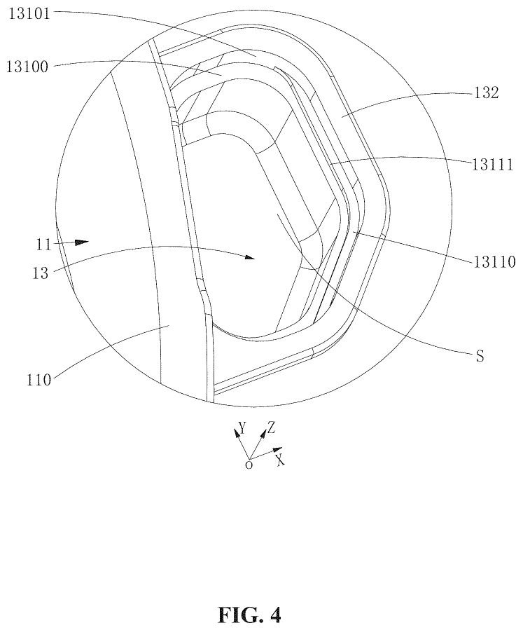

Please refer to FIG. 3 and FIG. 4. The recession part 1310 (the recession part 1310 may refer to FIG. 2) includes a first horizontal plane 13100 and a first vertical plane 13101, the first horizontal plane 13100 extends to the body part 130, and the first horizontal plane 13100 is disposed flush with the lower limit position of the acceptable range of gel accommodation of the gel accommodation space S. The first horizontal plane 13100 extends to the first vertical plane 13101. The first horizontal plane 13100 may be the bottom surface of the recession part 1310, i.e., the first horizontal plane 13100 may overlap the plane A1. The inner side end of the first horizontal plane 13100 may extend to the top end of the body part 130. For example, the inner side end of the first horizontal plane 13100 may extend to the top end of the side surface of the body part 130. The outer side end of the first horizontal plane 13100 extends to the first vertical plane 13101 and the second vertical plane 13111.

As shown in FIG. 4, the first horizontal plane 13100 extends to the first vertical plane 13101 and the second vertical plane 13111, and the first vertical plane 13101 and the second vertical plane 13111 may prevent the damper gel 2 from overflowing after the damper gel 2 passes through the first horizontal plane 13100.

The first horizontal plane 13100 may be parallel to the XOY plane, and the trend of the first horizontal plane 13100 may be shown as the C shape. The first vertical plane 13101 may be a columnar surface of which the trend is C-shaped, and two ends of the first vertical plane 13101 and the outer side surface of the boss 110 of the motion component 11 may cross each other. The first vertical plane 13101 may be parallel to the z-axis. Because the first horizontal plane 13100 is disposed flush with the lower limit position of the acceptable range of gel accommodation of the gel accommodation space S and the first horizontal plane 13100 is the plane, the area of the first horizontal plane 13100 is greater than the conventional capacity mark (e.g., the scale line), and the recession part 1310 (the recession part 1310 may refer to FIG. 2) can be easily distinguished.

As shown in FIG. 3, optionally, the first horizontal plane 13100 extends from the body part 130 in the direction far away from the central axial line of the body part 130. The first horizontal plane 13100 may extend from the body part 130 in the direction far away from the central axial line of the body part 130 along the radial direction of the body part 130. For example, the first horizontal plane 13100 may outwardly extend from the top end of the body part 130 along the direction vertical to the z-axis. By extending the first horizontal plane 13100 from the body part 130 in the direction far away from the central axial line of the body part 130, the gel accommodation space S may expand to accommodate the more damper gel 2.

As shown in FIG. 2, optionally, the deforming part 131 further includes a protrusion part 1311, the protrusion part 1311 is connected to the recession part 1310, the top of the protrusion part 1311 is disposed flush with the upper limit position of the acceptable range of gel accommodation of the gel accommodation space S, and the protrusion part 1311 projects from the recession part 1310. The protrusion part 1311 and the recession part 1310 may be integrally formed. The trend of the protrusion part 1311 may be a J shape, and the cross section of the protrusion part 1311 may be a rectangle. The protrusion part 1311 may be located on the inner side of the recession part 1310. The length of the protrusion part 1311 is less than the length of the recession part 1310. The shape of the protrusion part 1311 may be shown as the step shape, and the protrusion part 1311 projects with respect to the recession part 1310. The upper limit position of the acceptable range of gel accommodation of the gel accommodation space S may be the upper limit interface (e.g., the plane A2) of the acceptable range of gel accommodation of the gel accommodation space S.

As shown in FIG. 2, the protrusion part 1311 is disposed and the top of the protrusion part 1311 is arranged to be disposed flush with the upper limit position of the acceptable range of gel accommodation of the gel accommodation space S so that secondary distinction may be still performed on the contact between the protrusion part 1311 and the damper gel 2 even though the vision (human vision or machine vision) can not distinguish that the gel accommodation space S has been filled with the damper gel 2 after the damper gel 2 reaches the recession part 1310 during the damper gel 2 dispensation. Hence, visual distinction on whether the damper gel 2 fills the gel accommodation space S become more reliable.

Please refer to FIG. 2 and FIG. 3. Optionally, the recession part 1310 includes a first horizontal plane 13100, and the protrusion part 1311 is disposed on the first horizontal plane 13100. The protrusion part 1311 may be formed by extending the first horizontal plane 13100 along the direction parallel to the positive direction of the z-axis. Because the recession part 1310 and the body part 130 are open and the protrusion part 1311 is disposed on the first horizontal plane 13100, it may be convenient to observe the protrusion part 1311 without obstructions.

Please refer to FIG. 2 and FIG. 3. Optionally, the protrusion part 1311 includes a second horizontal plane 13110 and a second vertical plane 13111. The second horizontal plane 13110 extends to the recession part 1310, and the second horizontal plane 13110 is disposed flush with the upper limit position of the acceptable range of gel accommodation of the gel accommodation space S. The second horizontal plane 13110 extends to the second vertical plane 13111. The second horizontal plane 13110 may be parallel to the first horizontal plane 13100, and the second horizontal plane 13110 may be located above the first horizontal plane 13100. The second horizontal plane 13110 may be the top surface of the protrusion part 1311, i.e., the second horizontal plane 13110 may overlap the plane A2.

Please refer to FIG. 2 and FIG. 3. The inner side end of the second horizontal plane 13110 may extend to the top end of the second vertical plane 13111. The outer side end of the second horizontal plane 13110 may extend to the recession part 1310. For example, the outer side end of second horizontal plane 13110 may extend to the first vertical plane 13101. The second horizontal plane 13110 may be parallel to the XOY plane, and the trend of the second horizontal plane 13110 may be shown as the J shape. Because the second horizontal plane 13110 is disposed flush with the upper limit position of the acceptable range of gel accommodation of the gel accommodation space S and the second horizontal plane 13110 is the plane, the area of the second horizontal plane 13110 is greater than the conventional capacity mark (e.g., the scale line), and the protrusion part 1311 can be easily distinguished.

Because the first horizontal plane 13100 is disposed flush with the lower limit position of the acceptable range of gel accommodation of the gel accommodation space S and the first horizontal plane 13100 is the plane, the area of the first horizontal plane 13100 is greater than the conventional capacity mark (e.g., the scale line), and the recession part 1310 (the recession part 1310 may refer to FIG. 2) can be easily distinguished. In some embodiments, the extending distance of the C-shaped trend of the first horizontal plane 13100 on the XOY plane is greater than the extending distance of the J-shaped trend of the second horizontal plane 13110 and the second vertical plane 13111 of the protrusion part 1311 on the XOY plane so that one part of the first horizontal plane 13100 would be connected to the first vertical plane 13101 and the other part of the first horizontal plane 13100 would be connected to the second vertical plane 13111. Because the area of the XOY plane occupied by the protrusion part 1311 is smaller in addition to the structure of the more obvious protrusion part 1311, the damper gel tank 13 remains the more amount of gel accommodation when the gel height of the damper gel 2 is located between the plane A1 and the plane A2.

As shown in FIG. 4, the second vertical plane 13111 may be the columnar surface of which the trend is J-shaped, and two ends of the second vertical plane 13111 and the middle section of the first vertical plane 13101 are tangential to each other. The second vertical plane 13111 may be located on the inner side of the first vertical plane 13101, i.e., the distance between the second vertical plane 13111 and the central axial line of the body part 130 (the body part may refer to FIG. 2) is less than the distance between the first vertical plane 13101 and the central axial line of the body part 130. The second vertical plane 13111 may be parallel to the z-axis.

Please refer to FIG. 2 and FIG. 4. Optionally, the recession part 1310 includes the first vertical plane 13101, and the first vertical plane 13101 is connected to the protrusion part 1311. The middle section of the first vertical plane 13101 may upwardly extend from the top surface of the protrusion part 1311 along the positive direction parallel to the z-axis. The first vertical plane 13101 and the protrusion part 1311 may be integrally formed. The second horizontal plane 13110 extends to the first vertical plane 13101. The outer side end of the second horizontal plane 13110 may extend to the bottom of the middle section of the first vertical plane 13101. Because the second horizontal plane 13110 extends to the first vertical plane 13101, the first vertical plane 13101 may prevent the damper gel 2 from overflowing after the damper gel 2 passes through the second horizontal plane 13110.

As shown in FIG. 3, optionally, the second horizontal plane 13110 extends from the second vertical plane 13111 in the direction far away from the central axial line of the body part 130. For example, the second horizontal plane 13110 may depart from the central axial line of the body part 130 from the top end of the second vertical plane 13111 along the direction vertical to the z-axis and extends to the bottom of the middle section of the first vertical plane 13101. By extending the second horizontal plane 13110 from the second vertical plane 13111 in the direction far away from the central axial line of the body part 130, the gel accommodation space S may expand to accommodate the more damper gel 2.

As shown in FIG. 2, optionally, the damper gel tank 13 further includes the wall 132, and the wall 132 encompasses the recession part 1310. The wall 132 may be the protrusion formed by upwardly extending from the top surface of the motion component 11 along the direction parallel to the positive direction of the z-axis. The shape of the wall 132 may be annular. The deforming part 131 and the wall 132 are coaxially disposed. The deforming part and the wall 132 may be integrally formed.

Please refer to FIG. 2 and FIG. 3. Optionally, the recession part 1310 includes the first vertical plane 13101, and the first vertical plane 13101 and the inner side wall of the wall 132 are disposed with coplanarity. The top of the first vertical plane 13101 and the inner side wall of the C-shaped wall of the wall 132 are disposed with coplanarity. The top surface of the wall 132 may be parallel to the XOY plane. Because the first vertical plane 13101 and the inner side wall of the wall 132 are disposed with coplanarity, the transition between the first vertical plane 13101 and the inner side wall of the wall 132 may be smoother, and it is convenient for processing.

As shown in FIG. 2, optionally, the wall 132 is disposed on the top of the recession part 1310. The wall 132 and the top of the recession part 1310 may be integrally formed. The wall 132 disposed on the top of the recession part 1310 may prevent the damper gel 2 in the gel accommodation space S from overflowing.

The damper gel tank and the voice coil motor provided by the embodiments of the present disclosure are described in detail by the above description. The person skilled in the art would have changes in specific implementation and application scope according to the idea of the embodiments of the present disclosure. In view of the above description, the content of the present disclosure should not be construed as limitations of the present disclosure, and equivalent modification or changes according to the idea and the spirit of the present disclosure should be construed as being included within the claims of the present disclosure.

What is claimed is:

1. A damper gel tank comprising:
a body part; and
a deforming part forming gel accommodation space with the body part and comprising a recession part and a protrusion part, wherein the body part is connected to the recession part, a bottom of the recession part is disposed flush with a lower limit position of an acceptable range of gel accommodation of the gel accommodation space, and the recession part recesses along a radial direction of the body part; the protrusion part is connected to the recession part, a top of the protrusion part is disposed flush with an upper limit position of the acceptable range of gel accommodation of the gel accommodation space, and the protrusion part projects from the recession part.

2. The damper gel tank according to claim 1, wherein the recession part is disposed on a top end of the body part.

3. The damper gel tank according to claim 1, wherein the recession part comprises a first horizontal plane extending to the body part, and the first horizontal plane is disposed flush with the lower limit position of the acceptable range of gel accommodation of the gel accommodation space.

4. The damper gel tank according to claim 3, wherein the first horizontal plane extends from the body part in a direction far away from a central axial line of the body part.

5. The damper gel tank according to claim 4, wherein the recession part further comprises a first vertical plane, and the first horizontal plane extends to the first vertical plane.

6. The damper gel tank according to claim 1, wherein the recession part comprises a first horizontal plane where the protrusion part is disposed.

7. The damper gel tank according to claim 1, wherein the protrusion part further comprises a second horizontal plane extending to the recession part, and the second horizontal plane is disposed flush with the upper limit position of the acceptable range of gel accommodation of the gel accommodation space.

8. The damper gel tank according to claim 7, wherein the recession part comprises a first vertical plane connected to the protrusion part.

9. The damper gel tank according to claim 8, wherein the second horizontal plane extends to the first vertical plane.

10. The damper gel tank according to claim 7, wherein the protrusion part further comprises a second vertical plane, and the second horizontal plane extends to the second vertical plane.

11. The damper gel tank according to claim 10, wherein the second horizontal plane extends from the second vertical plane in a direction far away from a central axial line of the body part.

12. The damper gel tank according to claim 1, further comprising a wall encompassing the recession part.

13. The damper gel tank according to claim 12, wherein the recession part further comprises a first vertical plane, and the first vertical plane and an inner side wall of the wall are disposed with coplanarity.

14. The damper gel tank according to claim 12, wherein the wall is disposed on a top of the recession part.

15. A voice coil motor comprising a case, a motion component, a damper pin and a damper gel tank according to claim 1, wherein the motion component is movably disposed on the case, the damper gel tank is disposed on the motion component, there is damper gel disposed in the damper gel tank, and the damper pin is fixed on the case and is partially inserted into the damper gel.

16. The voice coil motor according to claim 15, wherein the damper gel tank comprises a wall encompassing the deforming part and protruding with respect to the motion component.

17. The voice coil motor according to claim 15, wherein the recession part comprises a first horizontal plane extending to the body part, and the first horizontal plane is disposed flush with the lower limit position of the acceptable range of gel accommodation of the gel accommodation space.

18. The voice coil motor according to claim 15, wherein the protrusion part further comprises a second horizontal plane extending to the recession part, and the second horizontal plane is disposed flush with the upper limit position of the acceptable range of gel accommodation of the gel accommodation space.
